(19) United States
(12) Patent Application Publication
(10) Pub. No.: US 2026/0330294 A1
(43) Pub. Date: Oct. 22, 2026

(54) SELF-SUPERVISED LEARNING FOR REAL-TIME CALIBRATION OF DYNAMIC IMAGE SENSORS

(71) Applicant: NVIDIA Corporation, Santa Clara, CA (US)

(72) Inventors: Donghyun Yoo, Fairfax, VA (US); Joonhwa Shin, Santa Clara, CA (US)

(21) Appl. No.: 19/183,138

(22) Filed: Apr. 18, 2025

(51) Int. Cl. G06N 20/00; G06T 7/80; G06V 10/44

(52) U.S. Cl. CPC G06N 20/00; G06T 7/80; G06V 10/44

(57) ABSTRACT

In various examples, techniques for self-supervised learning for real-time calibration of dynamic image sensors is described herein. Systems and methods described herein may initially train one or more machine learning models to perform camera calibration with regard to a surface layout for a type of sport. For instance, synthetic training data representing synthetic images and/or real-world training data representing real-world images depicting sporting surfaces associated with the surface layout may be used to train the model(s). Systems and methods described herein may then perform self-supervised fine-tuning of the model(s) for a specific sporting surface that is also associated with the surface layout. For instance, image data representing images of the sporting surface, along with a reference surface that indicates at least dimensions and/or feature locations of the surface layout, may be used to fine-tune the model(s) to be more accurate at feature detection for the sporting surface.

### BACKGROUND

Camera calibration is a critical task for many computer vision applications, such as depth estimation, object localization, image augmentation, and three-dimensional (3D) reconstruction. In some circumstances, camera calibration includes estimating a projection matrix that represents parameters—such as intrinsic parameters and extrinsic parameters—which calibrate a global coordinate system with respect to a local coordinate system associated with a camera and/or images captured using the camera Performing camera calibration for static cameras is a relatively straightforward task, since values of the calibration parameters remain constant over a period of time. In contrast, performing camera calibration for dynamic cameras—cameras subjected to changes in self-position and/or changes to a field of view thereof—is a significantly more challenging task due to the need to update values of the calibration parameters to account for those changes. For example, for a camera that is used to broadcast sporting events, the camera may continuously move, rotate, and/or zoom in order to show specific aspects of the sporting event during the broadcast. As such, the values of the calibration parameters of the camera need to be continuously updated to perform specific tasks associated with the broadcast, such as augmenting images and/or localizing players.

To perform camera calibration for dynamic cameras, conventional software techniques initially perform feature detection to determine keypoints within images that are then used to perform the camera calibration, such as by estimating the projection matrix. However, in many scenarios, performing keypoint detection may be difficult. For instance, and with regard to sporting events, different arenas, courts, fields, and/or other sporting surfaces associated with a sport may vary in appearance and/or design. For example, even though the overall layouts of basketball courts may be similar—such as the dimensions and/or the locations of features—the basketball courts may still include different colors, logos, and/or locations of logos that make camera calibration (e.g., feature detection) difficult.

Additionally, conventional hardware techniques use specialized hardware that measures motion of a camera, such as lateral movements, rotations, and/or zooming. For instance, the specialized hardware may include at least sensors that are attached to the camera and/or a mounting device of the camera that measure the motion. This motion is then used to perform the camera calibration, such as by estimating the projection matrix. However, these conventional techniques may require a large amount of human resources and/or time to prepare, such as to calibrate the camera with regard to a sporting surface. Additionally, the cameras require the specialized hardware to perform the camera calibration.

### SUMMARY

Embodiments of the present disclosure relate to self-supervised learning for real-time calibration of dynamic image sensors. The dynamism of the image sensor (e.g., camera) can relate to its own movement, or that of a field of view (FOV) of the camera. A dynamic camera can be a so-called “pan translate zoom” (PTZ) camera, such as those as are commonly used in broadcasting sporting events. Systems and methods described herein may initially train one or more machine learning models (referred to as the model(s)) to perform dynamic camera calibration with regard to a surface layout for a type of sport. For instance, synthetic training data representing synthetic images depicting sporting surfaces associated with the surface layout and/or real-world training data representing real-world images depicting sporting surfaces associated with the surface layout may be used to train a base model(s). Systems and methods described herein may then perform fine-tuning of the base model(s) for a specific sporting surface that is also associated with the surface layout. For instance, image data (e.g., test data) representing images of the sporting surface, along with a reference surface that indicates at least dimensions and/or feature locations of the surface layout, may be used to fine-tune the base model(s) to more accurately perform camera calibration for the specific sporting surface. By performing such training, the fine-tuned model(s) may better determine camera calibration parameters for a dynamic camera that is capturing the specific sporting surface.

In contrast to conventional systems, the systems of the present disclosure, in some embodiments, use the synthetic training data and/or the real-world training data to initially train the base model(s) to determine feature detection for a type of sporting surface with varying appearances. As such, by using at least the synthetic training data, the base model(s) may be trained using additional examples of sporting surfaces that include varying appearances with respect to one another. Additionally, to improve the overall performance of the base model(s) for a specific sporting surface that includes a unique appearance, the systems of the present disclosure then fine-tune the base model(s) using the self-supervised learning based on the test data that represents the specific sporting surface along with the reference layout. As described in more detail herein, by performing such training, the performance of the fine-tuned model(s) may be improved for specific camera calibration tasks—such as feature detection (e.g., keypoint detection)—with regard to the unique appearance of the specific sporting surface.

Additionally, in contrast to the conventional systems that use specialized hardware to perform camera calibration, the systems of the present disclosure, in some embodiments, are able to perform camera calibration using software and/or without the need of specialized hardware.

### BRIEF DESCRIPTION OF THE DRAWINGS

The present systems and methods for self-supervised learning for real-time calibration of dynamic image sensors are described in detail below with reference to the attached drawing figures, wherein:

FIG. 1A illustrates an example data flow diagram for a process of training one or more machine learning models to perform feature detection—such as for camera calibration associated with a surface type, in accordance with some embodiments of the present disclosure;

FIG. 1B illustrates an example data flow diagram for a process of fine-tuning one or more machine learning models to perform feature detection—such as for camera calibration associated with a specific sporting surface, in accordance with some embodiments of the present disclosure;

FIG. 2 illustrates an example of a reference surface associated with a type of sport, in accordance with some embodiments of the present disclosure;

FIG. 3 illustrates an example of synthetic training data representing sporting surfaces, in accordance with some embodiments of the present disclosure;

FIG. 4 illustrates an example of a process for training one or more machine learning models using synthetic training data, in accordance with some embodiments of the present disclosure;

FIG. 5 illustrates an example of real-world training data representing sporting surfaces, in accordance with some embodiments of the present disclosure;

FIG. 6 illustrates an example of a process for training one or more machine learning models using real-world training data, in accordance with some embodiments of the present disclosure;

FIG. 7 illustrates an example of test data representing a specific sporting surface that includes a unique appearance, in accordance with some embodiments of the present disclosure;

FIG. 8 illustrates an example of one or more machine learning models annotating test images, in accordance with some embodiments of the present disclosure;

FIG. 9 illustrates an example of fine-tuning one or more machine learning models using test data associated with a specific sporting surface, in accordance with some embodiments of the present disclosure;

FIG. 10 illustrates an example data flow diagram for a process of using one or more fine-tuned models to perform camera calibration with respect to a specific sporting surface, in accordance with some embodiments of the present disclosure;

FIG. 11 illustrates a flow diagram showing a method for fine-tuning one or more machine learning models for performing camera calibration with respect to a sporting surface, in accordance with some embodiments of the present disclosure;

FIG. 12 illustrates a flow diagram showing a method for sampling images to determine one or more images for fine-tuning one or more machine learning models, in accordance with some embodiments of the present disclosure;

FIG. 13 illustrates a flow diagram showing a method for training one or more machine learning models to perform feature detection using both synthetic data and real-world data, in accordance with some embodiments of the present disclosure;

FIG. 14 is a block diagram of an example computing device suitable for use in implementing some embodiments of the present disclosure; and

FIG. 15 is a block diagram of an example data center suitable for use in implementing some embodiments of the present disclosure.

### DETAILED DESCRIPTION

Systems and methods are disclosed for self-supervised learning for real-time calibration of dynamic image sensors. For instance, in some examples, a system(s) may generate synthetic training data that includes at least synthetic input data representing synthetic images of sporting surfaces associated with a sport along with synthetic ground truth data representing at least features associated with the synthetic images. Non-limiting examples of features include keypoints, edges, lines, vertices, ellipses, circles, and polygons. As described herein, since sporting surfaces associated with a same sport may differ in appearance—such as basketball courts including different colors and/or logos—the synthetic images may represent the sporting surfaces using various appearances. However, the layouts of the sporting surfaces may be uniform and/or similar to one another, such as by having the same dimensions and/or features. The system(s) may then train the model(s) using the synthetic training data. For example, the system(s) may update one or more parameters, weights, and/or biases associated with the model(s) based at least on differences between one or more predicted features determined by the model(s) processing the synthetic input data and the synthetic ground truth features.

In some examples, the system(s) may also obtain real-world training data that includes at least real-world input data representing real-world images of sporting surfaces associated with the sport along with real-world ground truth data representing at least features associated with the real-world images. Again, since sporting surfaces associated the same sport may differ in appearance, the real-world images may also represent the sporting surfaces using various appearance. For instance, the real-world images may depict actual sporting surfaces associated with different teams, clubs, organizations, and/or the like. The system(s) may then further train the model(s) using the real-world data. For example, the system(s) may further update the one or more parameters, weights, and/or biases associated with the model(s) based at least on differences between predicted features determined by the model(s) processing the real-world input data and the real-world ground truth features.

By performing such processes to initially train the model(s), which may also be referred to as the “base model(s)” in some examples, the base model(s) may be trained to determine features associated with sporting surfaces that include the surface layout associated with the sport. For example, if the sport includes basketball, then the base model(s) may be trained to determine features for different basketball courts that include a uniform and/or similar layout, but with varying visual appearances. Additionally, by using the synthetic training data along with the real-world training data, the base model(s) may be trained using multiple examples of sporting surfaces that include different appearances, but with requiring less manual labeling of real-world training data.

In some examples, the system(s) (and/or another system(s)) may then fine-tune the base model(s) to perform feature detection associated with a specific sporting surface. For instance, the system(s) may receive image data (referred to, in some examples, as “test data”) representing test images of the specific sporting surface captured using one or more image sensors. The system(s) may then process the test data using the base model(s) that generates output data representing features (also referred to as the “predicted features”) associated with the specific sporting surface as represented by the test images and/or confidence scores associated with the predicted features. In some examples, the system(s) may then select one or more of the test images for fine-tuning the base model(s) based at least on the confidence scores. For example, the system(s) may analyze the confidence scores to determine final scores associated with the test images, such as based on the average of the confidence scores, the median of the confidence scores, the mode of the confidence scores, and/or using any other mathematical formula. The system(s) may then select the test image(s) that is associated with one or more of the highest final scores. By performing such processes, the system(s) may select the most accurate test image(s) for better fine-tuning of the base model(s).

To fine-tune the base model(s) using a test image, the system(s) may process the predicted features associated with the test image to determine values for calibration parameters that relate a global coordinate system associated with the specific sporting surface to a local coordinate system associated with the test image. As described herein, the values of the calibration parameters may be represented using a matrix—such as a 3×4 matrix (and/or any other type of matrix)—that indicates one or more intrinsic parameters (e.g., focal length, principal points, skewness, etc.) and/or one or more extrinsic parameters (e.g., rotation, translation, etc.) for performing the calibration. In some examples, the system(s) may determine the values of the calibration parameters using all of the predicted features from the test image. However, in some examples, the system(s) may determine the values of the calibration parameters using only a portion of the predicted features from the test image, such as one or more predicted features that include one or more confidence values that satisfy a threshold score (and/or any other technique, which is described in more detail herein).

The system(s) may then use the values of the calibration parameters to project one or more three-dimensional (3D) features (also referred to as the “projected feature(s)”) associated with a reference surface corresponding to the specific sporting surface to the test image. For instance, the reference surface may include a layout related to the type of sporting surface—such as dimensions of the sporting surface, locations of features (e.g., keypoints, lines, etc.) of the sporting surface, and/or the like—which is uniform and/or similar across the sporting surfaces associated with the sport. The system(s) may then use the predicted feature(s) for the test image and the projected feature(s) for the test image to fine-tune the base model(s). For example, the system(s) may determine one or more losses based at least on comparing the predicted feature(s) to the projected feature(s) and then update one or more parameters, weights, and/or biases of the base model(s) using at least on the loss(es). As such, by performing such processes, the system(s) may fine-tune the base model(s) without requiring ground truth data that is associated with the specific sporting surface.

In some examples, the system(s) may then continue to perform these processes of fine-tuning the base model(s) until the occurrence of one or more events. For example, the system(s) may continue these processes of fine-tuning the base model(s) for a specific number of iterations, until the base model(s) satisfies a threshold accuracy (e.g., the predicted feature(s) for a test image is within a threshold accuracy to the projected feature(s) for the test image), and/or the occurrence of any other event. As such, by performing one or more of the processes described herein, the model(s) may initially be trained to perform feature detection for sporting surfaces that are associated with a specific sport—such as basketball, baseball, football, soccer, and/or any other sport—then further be fine-tuned for a specific sporting surface associated with the sport. This way, even if the sporting surfaces associated with the sport differ from one another in appearance—such as by including different colors, logos, and/or the like—the fine-tuned model(s) is still trained for the specific sporting surface for more improved performance.

In some examples, the system(s) may then perform one or more tasks using the fine-tuned model(s). For instance, such as during a broadcast of a sporting event associated with the sporting surface, the system(s) may receive image data representing images of the sporting event. The system(s) may then use the fine-tuned model(s) to process the image data and determine locations of features as represented by the image data. Additionally, the system(s) may use the locations of the features to determine the value(s) for the calibration parameter(s). In some examples, the system(s) may determine the value(s) for every image, every other image, every fourth image, every tenth image, and/or using any other interval associated with the images. The system(s) may then use the value(s) of the calibration parameter(s) to determine one or more locations of one or more objects located on the sporting surface, augment the image(s) using one or more overlays, and/or perform any other type of task associated with the sporting event.

While the examples herein describe generating the base model(s) and/or the fine-tuned model(s) for sporting surfaces, in other examples, similar processes may be used to train a model(s) for other types of surfaces. For example, if multiple warehouses include the same surface layout—such as with regard to the dimensions and/or locations of features—then the system(s) may initially train a model(s) to perform feature detection with regard to the surface layout of the warehouses. Additionally, the system(s) may further fine-tune the model(s) for a specific warehouse surface which may differ from the other warehouse surfaces in appearance (e.g., different colors, logos, etc.). For a second example, the system(s) may initially train a model(s) to perform feature detection with respect to intersections that include a uniform and/or similar layout. The system(s) may then fine-tune the model(s) for a specific intersection which may differ from the other intersections in appearance.

In some examples, the model(s) (e.g., diffusion model, machine learning models, deep neural networks, language models, LLMs, VLMs, multi-modal language models, perception models, tracking models, fusion models, transformer models, diffusion models, encoder-only models, decoder-only models, encoder-decoder models, neural rendering field (NERF) models, neural networks, etc.) described herein may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or a model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs—such as REST APIs. As such, and in some embodiments, the machine learning model(s) described herein may be deployed as an inference microservice to accelerate deployment of a model(s) on any cloud, data center, or edge computing system, while ensuring the data is secure.

For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring). The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems implementing large language models (LLMs), systems implementing one or more vision language models (VLMs), systems implementing one or more multi-modal language models, systems using or deploying one or more inference microservices, systems that incorporate deploy one or more machine learning models in a service or microservice along with an OS-level virtualization package (e.g., a container), systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

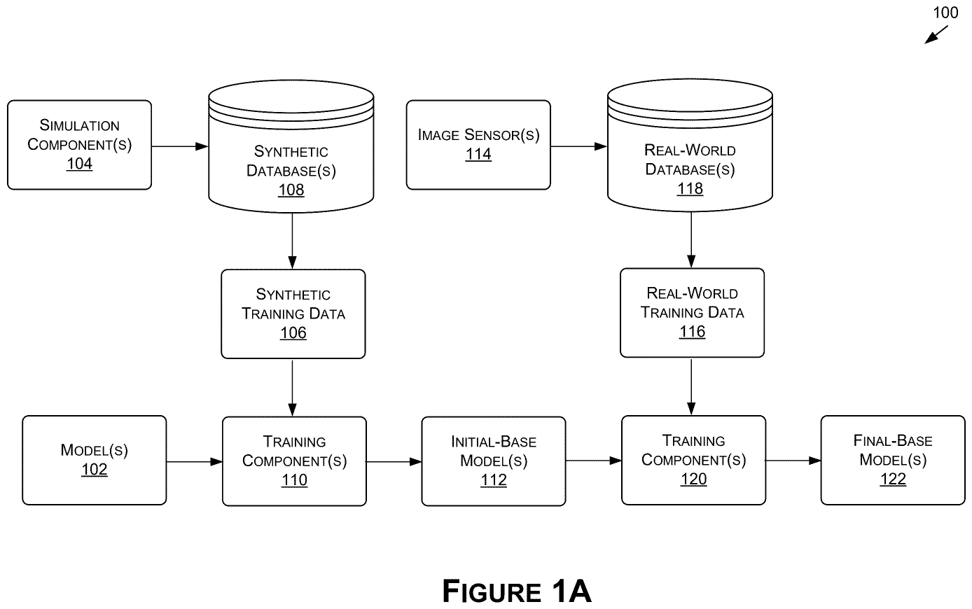

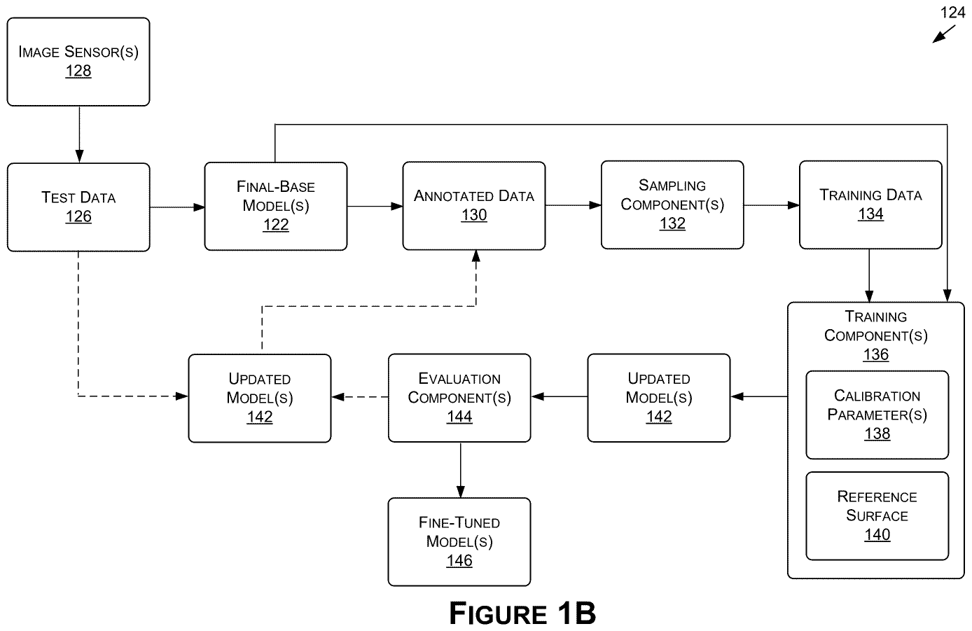

With reference to FIG. 1, FIG. 1A illustrates an example data flow diagram for a process 100 of training one or more machine learning models 102 to perform feature detection such as for camera calibration—associated with a surface type, in accordance with some embodiments of the present disclosure.

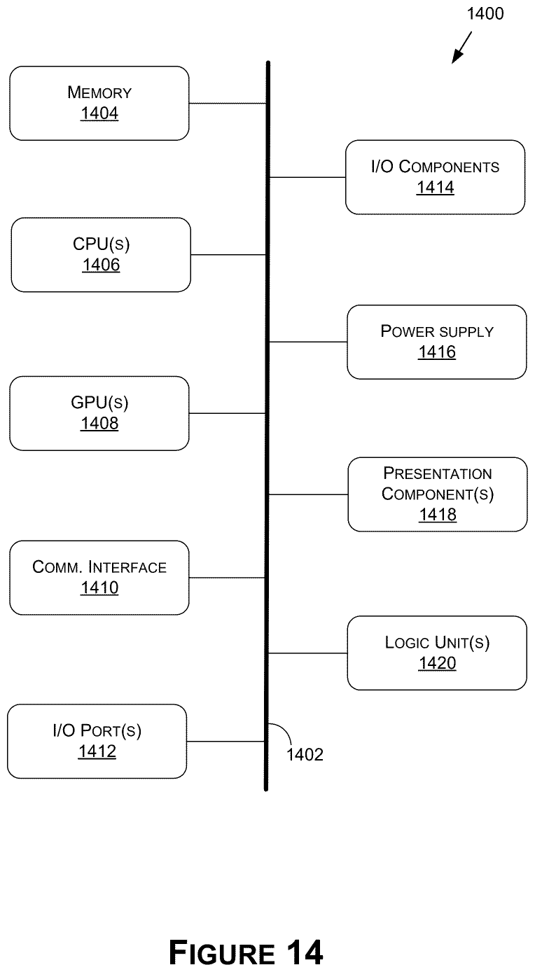

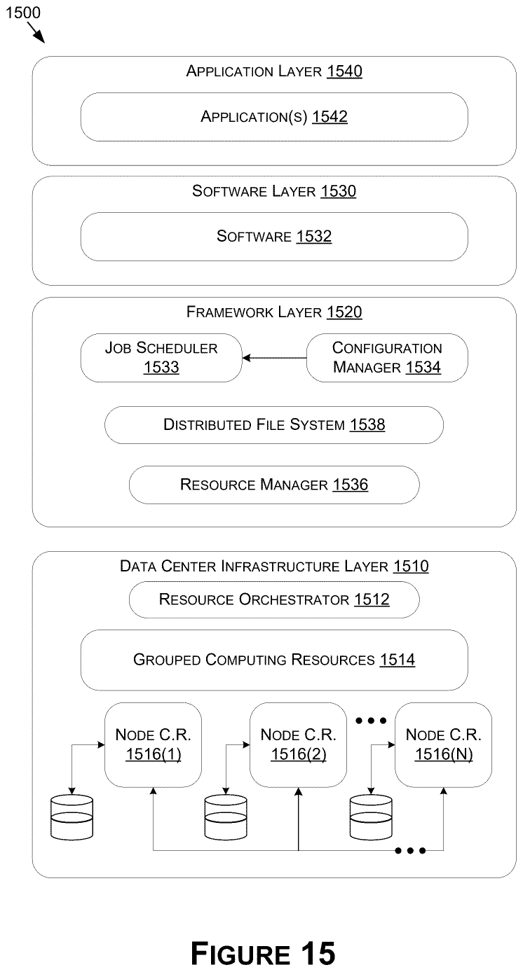

If should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the systems, methods, and processes described herein may be executed using similar components, features, and/or functionality to those of example computing device 1400 of FIG. 14 and/or example data center 1500 of FIG. 15.

For instance, the process 100 may include using one or more simulation components 104 to generate synthetic training data 106 for storage in one or more databases 108. As described herein, in some examples, the synthetic training data 106 may include training input data representing synthetic images depicting synthetic sporting surfaces that are associated with a type of sport, such as baseball, football, basketball, soccer, hockey, and/or any other sport. Additionally, since the synthetic sporting surfaces are associated with the same type of sport, the synthetic sporing surfaces may include a uniform and/or similar overall layout. For instance, the dimensions of the synthetic sporting surfaces, the locations of features associated with the synthetic sporting surfaces, and/or the like may be similar to one another. However, since real-world sporting surfaces may differ in appearance—such as by using different colors, logos, locations of logos, and/or the like—the synthetic sporting surfaces may also differ in appearances. For instance, the simulation component(s) 104 may also generate the synthetic sporting surfaces to include different colors, logos, locations of logos, and/or the like.

The synthetic training data 106 may further include ground truth data representing locations of features as represented by the synthetic images. For example, the ground truth data may represent at least locations of keypoints associated with the synthetic sporting surfaces as depicted by the synthetic images. In some examples, since the synthetic sporting surfaces include uniform and/or similar layouts, the ground truth data for the synthetic sporting surfaces may include the same and/or similarly labeled keypoints. This way, and as described in more detail herein, the model(s) 102 may be trained to determine similar keypoints for real-world sporting surfaces when determining calibration parameters.

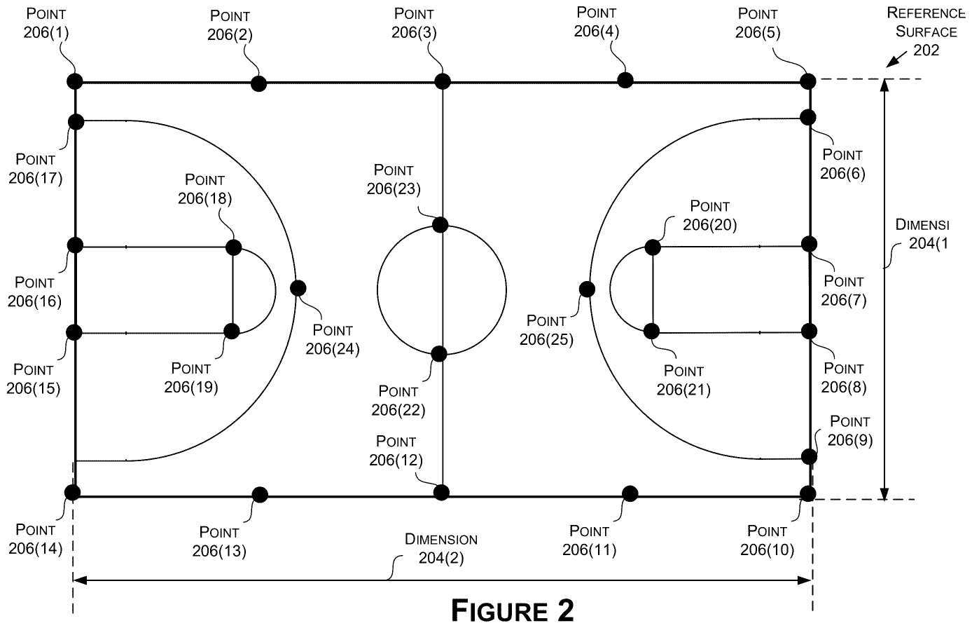

For more details, FIG. 2 illustrates an example of a reference surface 202 associated with a type of sport, in accordance with some embodiments of the present disclosure. As shown, the reference surface 202 may be associated with basketball and indicate at least dimensions 204(1)-(2) (also referred to singularly as “dimension 204” or in plural as “dimensions 204”) associated with a basketball court. While the example of FIG. 2 only illustrates two dimensions 204 that represent the width and length of the basketball court, in other examples, the reference surface 202 may further indicate dimensions of features of the basketball court. For example, the reference surface 202 may indicate at least dimensions associated with the half-court line, the three-point arc, the free-throw line, and the center circle (which are not labeled for clarity reasons).

The reference surface 202 further indicates locations of keypoints 206(1)-(25) (also referred to singularly as “keypoint 206” or in plural as “keypoints 206”) associated with the reference surface 202. For example, the keypoints 206 may be associated with locations on the features of the basketball court. In some examples, various techniques may be used to set the keypoints 206 associated with the reference surface 202. For example, the keypoints 206 may be uniformly arranged on the features, placed at locations of feature intersections (e.g., where two lines intersect), placed based on user inputs, and/or using any other technique. While the example of FIG. 2 illustrates the reference surface 202 as including twenty-five keypoints 206 with regard to the basketball court, in other examples, a reference surface may include any other number of keypoints associated with the basketball court (and/or any other type of sporting surface).

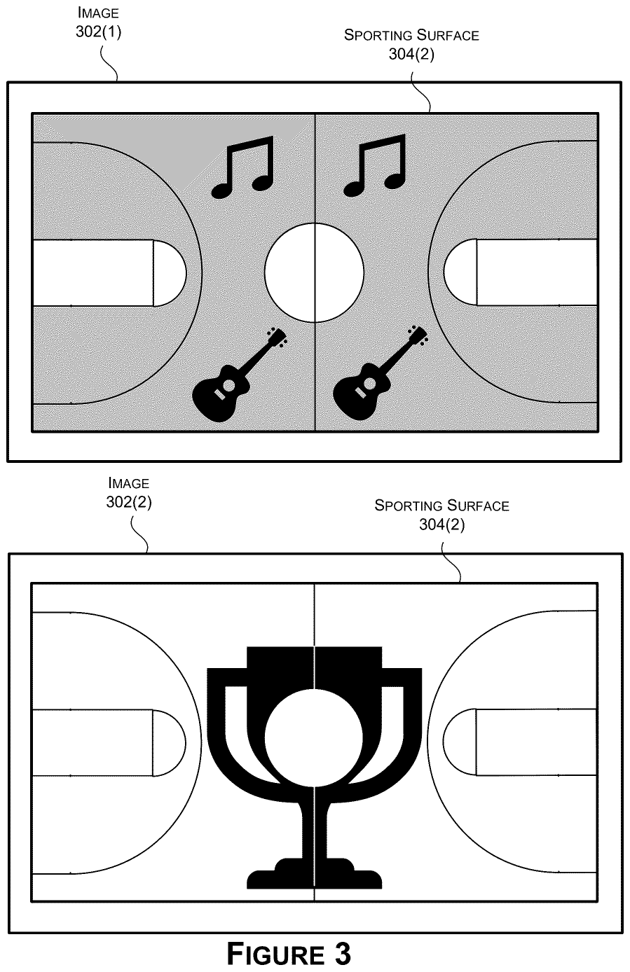

Next, FIG. 3 illustrates an example of synthetic training data representing sporting surfaces, in accordance with some embodiments of the present disclosure. As shown, the synthetic training data may represent at least synthetic images 302(1)-(2) (also referred to singularly as “synthetic image 302” or in plural as “synthetic images 302”) representing sporting surfaces 304(1)-(2) (also referred to singularly as “sporting surface 304” or in plural as “sporting surfaces 304”) that also include basketball courts. In the example of FIG. 3, the sporting surfaces 304 may include the same layout as the reference surface 202 from the example of FIG. 2, such as including the same dimensions and/or features (e.g., keypoints, lines, etc.), although not shown for clarity reasons. However, the appearances of the sporting surfaces 304 may differ from one another, such as by including different colors, logos, and/or locations of logos.

While the example of FIG. 3 illustrates the synthetic images 302 as depicting an entirety of the sporting surfaces 304, in other examples, synthetic images may only depict portions of sporting surfaces. Additionally, in some examples, synthetic images may depict sporting surfaces and/or portions of sporting surfaces at different angles and/or orientations. Furthermore, in some examples, synthetic images may depict sporting surfaces that include objects—such as players—located at different locations on the sporting surfaces and/or occluding at least a portion of the features of the sporting surfaces.

Referring back to the example of FIG. 1A, the process 100 may include using one or more training components 110 to train the model(s) 102 using at least a portion of the synthetic training data 106 from the database(s) 108. For example, the training component(s) 110 may input the training input data into the model(s) 102. The model(s) 102 may then process the training input data and generate output data representing locations of predicted features—such as predicted keypoints—associated with the synthetic images. Additionally, the training component(s) 110 may use the output data along with the ground truth data to update the model(s) 102. For example, the training component(s) 110 may determine one or more losses based at least on comparing the predicted features to the ground truth features. The training component(s) 110 may then use the loss(es) to update one or more parameters, weights, and/or biases associated with the model(s) 102. Based at least on training the model(s) 102, the training component(s) 110 may then output an initial-base model(s) 112 associated with the type of sport.

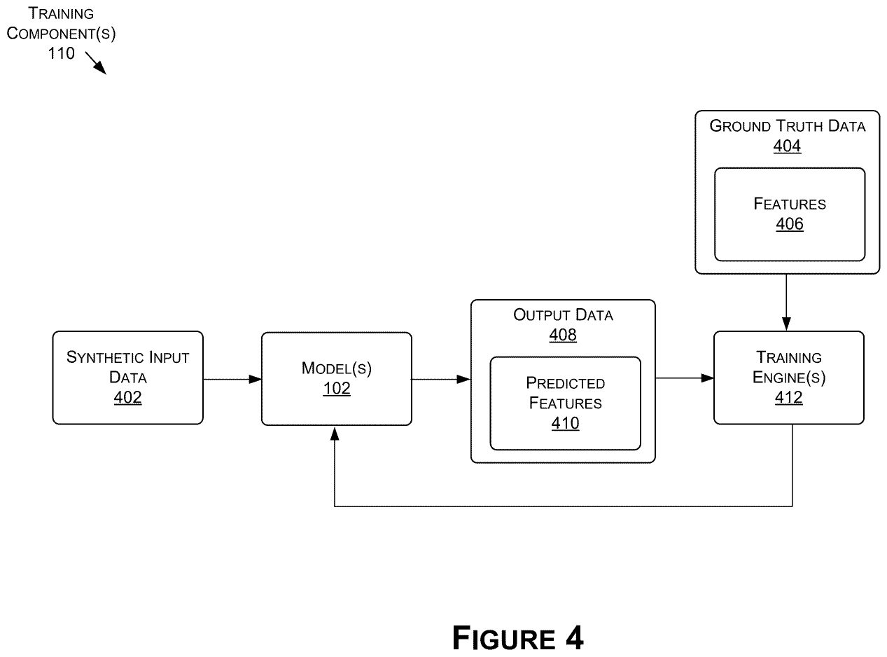

For more details, FIG. 4 illustrates an example of a process for training one or more machine learning models using synthetic training data, in accordance with some embodiments of the present disclosure. As shown, the training component(s) 110 may train the model(s) 102 using synthetic input data 402 representing synthetic images depicting synthetic sporting surfaces associated with a type of sport. For example, the synthetic input data 402 may represent at least the synthetic images 302 and/or one or more additional synthetic images depicting one or more additional synthetic sporting surfaces, where the synthetic sporting surfaces include various appearances. Additionally, as described herein, the synthetic images may depict an entirety of the synthetic sporting surfaces, portions of the synthetic sporting surfaces, various angles of the synthetic sporting surfaces, various orientations of the synthetic sporting surfaces, and/or any other configurations of the synthetic sporting surfaces.

As shown, the training component(s) 110 may train the model(s) 102 using the synthetic training data 402 along with corresponding synthetic ground truth data 404. As shown, the synthetic ground truth data 404 may represent locations of features 406 associated with the synthetic sporting surfaces as represented by the synthetic images. For instance, in some examples, the synthetic ground truth data 404 may represent locations of keypoints on the synthetic sporting surfaces as represented by the synthetic images, where the ground truth keypoints may correspond to the keypoints 206 of the reference surface 202. This way, during the training, the model(s) 102 may be trained to determine the locations of the keypoints 204 on any sporting surface that is associated with the type of sport.

To train the model(s) 102, the training component(s) 110 may input the synthetic input data 402 into the model(s) 102 which processes the synthetic input data 402 to generate output data 408 corresponding to the synthetic input data 402. For instance, the output data 408 may represent at least locations of predicted features 410 associated with the synthetic images. The training component(s) 110 may then use one or more training engines 412 that measure loss (e.g., error) in the output data 408 as compared to the synthetic ground truth data 404. For instance, the training engine(s) 412 may use one or more loss functions that measure the loss based at least on differences between the predicted features 410 and the ground truth features 406. The training engine(s) 412 may then perform backward pass computations to recursively compute gradients of the loss function(s) with respect to training parameters in order to update the parameters, weights, and/or biases of the model(s) 102.

Referring back to the example of FIG. 1A, the process 100 may include one or more image sensors 114 generating real-world training data 116 for storage in one or more databases 118. As described herein, in some examples, the real-world training data 116 may include training input data representing real-world images depicting real-world sporting surfaces that are associated with the same type of sport as the synthetic training data 106, such as baseball, football, basketball, soccer, hockey, and/or any other sport. Additionally, since the real-world sporting surfaces are associated with the same type of sport, the real-world sporing surfaces may include a uniform and/or similar overall layout. For instance, the dimensions of the real-world sporting surfaces, the locations of features associated with the real-world sporting surfaces, and/or the like may be similar to one another. However, and similar to the synthetic sporting surfaces, the real-world sporting surfaces to include various appearances, such as different colors, logos, locations of logos, and/or the like.

The real-world training data 116 may further include ground truth data representing locations of features as represented by the real-world images. For example, the ground truth data may represent at least locations of keypoints associated with the real-world sporting surfaces as depicted by the real-world images. In some examples, since the real-world sporting surfaces include uniform and/or similar layouts, the ground truth data for the real-world sporting surfaces may include the same and/or similarly labeled keypoints. This way, and as described in more detail herein, the model(s) 102 may further be trained to determine similar keypoints with real-world sporting surfaces when determining calibration parameters.

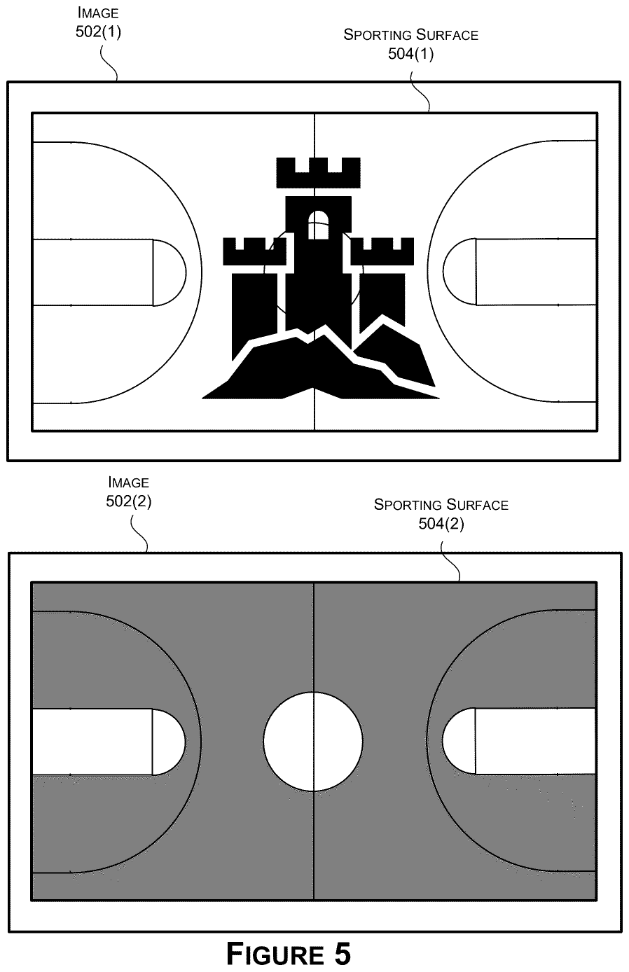

For more details, FIG. 5 illustrates an example of real-world training data representing sporting surfaces, in accordance with some embodiments of the present disclosure. As shown, the real-world training data may represent at least real-world images 502(1)-(2) (also referred to singularly as “real-world image 502” or in plural as “real-world images 502”) representing sporting surfaces 504(1)-(2) (also referred to singularly as “sporting surface 504” or in plural as “sporting surfaces 504”) that include basketball courts. In the example of FIG. 5, the sporting surfaces 504 may include the same layout as the reference surface 202 from the example of FIG. 2, such as including the same dimensions and/or features (e.g., keypoints, lines, etc.), although not shown for clarity reasons. However, the appearances of the sporting surfaces 504 may differ from one another, such as by including different colors, logos, and/or locations of logos.

While the example of FIG. 5 illustrates the real-world images 502 as depicting an entirety of the sporting surfaces 504, in other examples, real-world images may only depict portions of sporting surfaces. Additionally, in some examples, real-world images may depict sporting surfaces and/or portions of sporting surfaces at different angles and/or orientations. Furthermore, in some examples, real-world images may depict sporting surfaces that include objects—such as players—located at different locations on the sporting surfaces and/or occluding at least a portion of the features of the sporting surfaces.

Referring back to the example of FIG. 1A, the process 100 may include using one or more training components 120 (which, in some examples, may include the training component(s) 110) to train the initial-base model(s) 112 using at least a portion of the real-world training data 116 from the database(s) 118. For example, the training component(s) 120 may input the training input data into the initial-base model(s) 112. The initial-base model(s) 112 may then process the training input data and generate output data representing locations of predicted features—such as predicted keypoints—associated with the real-world images. Additionally, the training component(s) 120 may use the output data along with the ground truth data to update the initial-base model(s) 112. For example, the training component(s) 120 may determine one or more losses based at least on comparing the predicted features to the ground truth features. The training component(s) 120 may then use the loss(es) to update one or more parameters, weights, and/or biases associated with the initial-base model(s) 112. Based at least on training the initial-base model(s) 112, the training component(s) 120 may then output a final-base model(s) 122 associated with the type of sport.

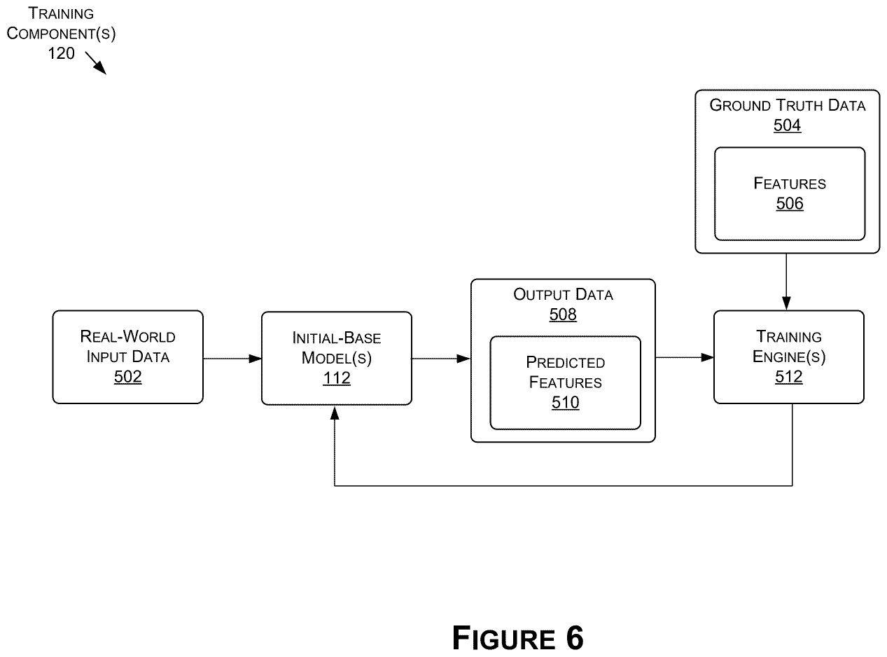

For more details, FIG. 6 illustrates an example of a process for training one or more machine learning models using real-world training data, in accordance with some embodiments of the present disclosure. As shown, the training component(s) 120 may train the initial-base model(s) 112 using real-world input data 602 representing real-world images depicting real-world sporting surfaces associated with a type of sport. For example, the real-world input data 602 may represent at least the real-world images 502 and/or one or more additional real-world images depicting one or more additional real-world sporting surfaces, where the sporting surfaces include various appearances. Additionally, as described herein, the real-world images may depict an entirety of the real-world sporting surfaces, portions of the real-world sporting surfaces, various angles of the real-world sporting surfaces, various orientations of the real-world sporting surfaces, and/or any other configurations of the real-world sporting surfaces.

As shown, the training component(s) 120 may train the initial-base model(s) 112 using the real-world training data 602 along with corresponding real-world ground truth data 604. As shown, the real-world ground truth data 604 may represent locations of features 608 associated with the real-world sporting surfaces as represented by the real-world images. For instance, in some examples, the real-world ground truth data 604 may represent locations of keypoints on the real-world sporting surfaces as represented by the real-world images, where the ground truth keypoints may correspond to the keypoints 206 of the reference surface 202. This way, during the training, the initial-base model(s) 112 may further be trained to determine the locations of the keypoints 204 on any sporting surface that is associated with the type of sport.

To train the initial-base model(s) 112, the training component(s) 120 may input the real-world input data 602 into the initial-base model(s) 112 which processes the real-world input data 602 to generate output data 608 corresponding to the real-world input data 602. For instance, the output data 608 may represent at least locations of predicted features 610 associated with the real-world images. The training component(s) 120 may then use one or more training engines 612 that measure loss (e.g., error) in the output data 608 as compared to the real-world ground truth data 604. For instance, the training engine(s) 612 may use one or more loss functions that measure the loss based at least on differences between the predicted features 610 and the ground truth features 606. The training engine(s) 612 may then perform backward pass computations to recursively compute gradients of the loss function(s) with respect to training parameters in order to update the parameters, weights, and/or biases of the initial-base model(s) 112.

Referring back to the example of FIG. 1A, by performing the process 100, the final-base model(s) 122 may be trained to determine the locations of features—such as keypoints—for sporting surfaces that are associated with the type of sport and/or may be trained to use the locations of the features to perform camera calibration with respect to the sporting surfaces. Additionally, by using both the synthetic training data 106 and the real-world training data 116 to perform the training, the final-base model(s) 122 may be trained using a greater number of example sporting surfaces—such as sporting surfaces that include different appearances with respect to one another—while not requiring human annotations for a large number of real-world training examples. For instance, in some examples, the synthetic training data 106 may represent a greater number of training examples as compared to the real-world training data 116. For example, the synthetic training data 106 may represent 1,000 synthetic images (and/or any other number of synthetic images) while the real-world training data 116 represents 50 real-world images (and/or any other number of real-world images).

As described herein, in some examples, the final-base model(s) 122 may further be fine-tuned, such as to improve the performance of the final-base model(s) 122 with respect to a specific sporting surface. This is because, in some examples, the specific sporting surface may include a different appearance as compared to the sporting surfaces (e.g., the synthetic sporting surfaces and/or the real-world sporting surfaces) for which the final-base model(s) 122 was trained. For instance, FIG. 1B illustrates an example data flow diagram for a process 124 of fine-tuning one or more machine learning models to perform feature detection—such as for camera calibration—associated with a specific sporting surface, in accordance with some embodiments of the present disclosure.

As shown, the process 124 may include receiving test data 126 obtained using one or more image sensors 128. As described herein, in some examples, the test data 126 may include at least image data representing one or more test images depicting the specific sporting surface for which the final-base model(s) 122 is configured for fine-tuning. Additionally, the test image(s) may represent different aspects of the specific sporting surface. For example, the test image(s) may depict an entirety of the specific sporting surface, one or more portions of the specific sporting surface, one or more angles of the specific sporting surface, one or more orientations of the specific sporting surface, and/or any other configurations of the specific sporting surface.

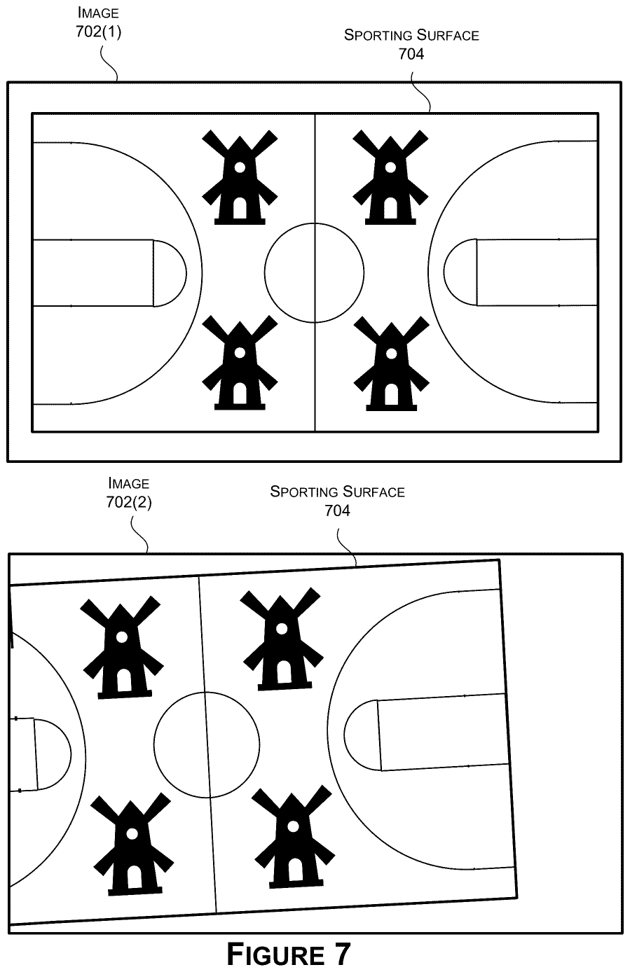

For instance, FIG. 7 illustrates an example of test data representing a specific sporting surface that includes a unique appearance, in accordance with some embodiments of the present disclosure. As shown, the test data may represent at least test images 702(1)-(2) (also referred to singularly as “test image 702” or in plural as “test images 702”) representing a specific sporting surface 704. Additionally, the test images 702 represent the specific sporting surface 704 from different angles, orientations, and/or zoom levels. For instance, and as shown, the first test image 702(1) represents an entirety of the specific sporting surface 704 while the second test image 702(2) represents a portion of the specific sporting surface 704 that is taken from a different angle and zoomed in.

Referring back to the example of FIG. 1B, the process 124 may include the final-base model(s) 122 processing at least a portion of the test data 126 to generate annotated data 130 representing locations of features associated with the test image(s). For instance, in some examples, the annotated data 130 may represent the locations of the keypoints associated with the specific sporting surface for which the final-base model(s) 122 was initially trained to detect. Additionally, in some examples, the annotated data 130 may represent confidence values associated with the detected features. In such examples, the confidence values may be within a range—such as 0 to 1 (and/or any other range)—where a lower value indicates that the final-base model(s) 122 is not confident in a location of a detected feature and a higher value indicates that the final-base model(s) 122 is confidence in a location of a detected feature.

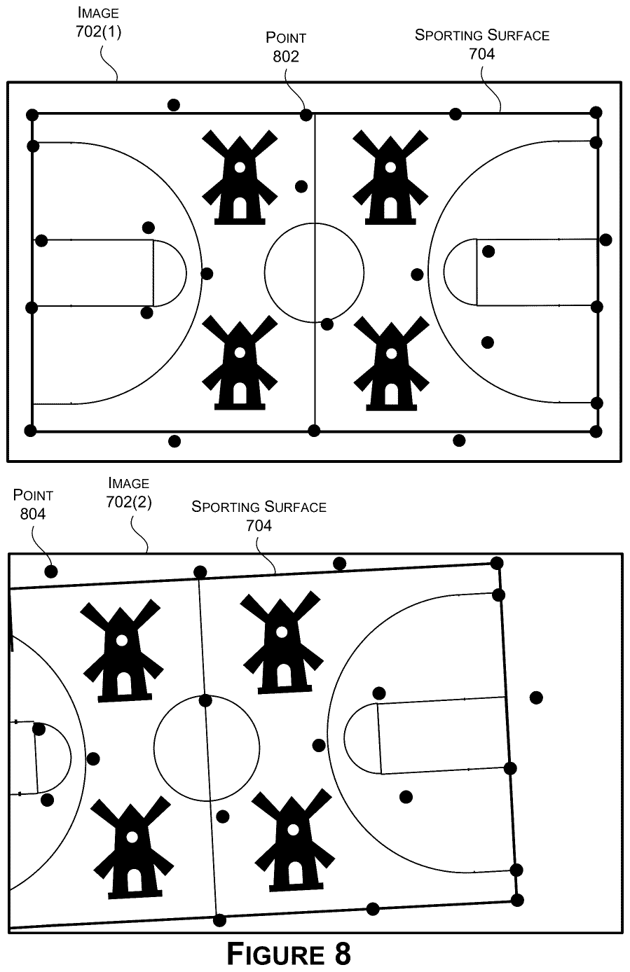

For instance, FIG. 8 illustrates an example of the final-base model(s) 122 annotating test images 702, in accordance with some embodiments of the present disclosure. As shown, the final-base model(s) 122 may process the test data representing the first test image 702(1) and, based at least on the processing, determine locations of features associated with the specific sporting surface 704 as represented by the first test image 702(1). For instance, in the example of FIG. 8, the final-base model(s) 122 may determine locations of keypoints 802 (although only one is labeled for clarity reasons) that correspond to the keypoints 206 for which the final-base model(s) 122 was originally trained. In some examples, the final-base model(s) 122 may further determine confidence values associated with the keypoints 802.

Additionally, the final-base model(s) 122 may process the test data representing the second test image 702(2) and, based at least on the processing, determine locations of features associated with the specific sporting surface 704 as represented by the second test image 702(2). For instance, in the example of FIG. 8, the final-base model(s) 122 may determine locations of keypoints 804 (although only one is labeled for clarity reasons) that also correspond to the keypoints 206 for which the final-base model(s) 122 was originally trained. In some examples, the final-base model(s) 122 may further determine confidence values associated with the keypoints 802.

Referring back to the example of FIG. 1B, the process 124 may include using one or more sampling components 132 to analyze the annotated data 130 and select training data 134 for fine-tuning the final-base model(s) 122. For instance, in some examples, the sampling component(s) 132 may select the training data 134 to include one or more of the test images that are associated with the highest confidences for the detected features. For example, the sampling component(s) 132 may use the confidence scores associated with the detected features for the test image(s), as represented by the annotated data 130, to determine one or more final scores associated with the test image(s). For instance, and for a test image, the sampling component(s) 132 may determine a final score based on the average of the confidence scores, the median of the confidence scores, the mode of the confidence scores, and/or using any other mathematical formula. The sampling component(s) 132 may then use the final score(s) to select the test image(s) represented by the training data 134. For example, the sampling component(s) 132 may select the test image that is associated with the highest final score.

For instance, and in the example of FIG. 8, the sampling component(s) 132 may use the confidence scores associated with the keypoints 802 to determine a first final score associated with the first test image 702(1). Additionally, the sampling component(s) 132 may use the confidence scores associated with the keypoints 804 to determine a second final score associated with the second test image 702(2). The sampling component(s) 132 may then use the final scores to select one of the test images 702 for fine-tuning the final-base model(s) 122. For instance, in the example of FIG. 8, the sampling component(s) 132 may select the second test image 702(2) for fine-tuning the final-base model(s) 122 based at least on the second final score being greater than the first final score.

The process 124 may then include using one or more training components 136 to fine-tune the final-base model(s) 122 using at least the training data 134. As described herein, in some examples, the training component(s) 136 is able to fine-tune the final-base model(s) 122 using self-supervision, such as without requiring the generation of ground truth data. For instance, and for a test image represented by the training data 134, the training component(s) 136 may use the detected features for the test image to determine one or more values for one or more calibration parameters 138 that calibrate the specific sporting surface with respect to the test image. For example, the value(s) of the calibration parameter(s) 138 may relate a global coordinate system associated with the specific sporting surface to a local coordinate system associated with the test image. As described herein, in some examples, the value(s) of the calibration parameter(s) 138 may be represented using a matrix—such as a 3×4 matrix (and/or any other type of matrix)—that indicates one or more intrinsic parameters (e.g., focal length, principal points, skewness, etc.) and/or one or more extrinsic parameters (e.g., rotation, translation, etc.) for performing the calibration.

The training component(s) 136 may then use the value(s) of the calibration parameter(s) 138 to project features associated with a reference surface 140 to the test image. In some examples, the training component(s) 136 may project all of the features from the reference surface 140 that correspond to the detected features in the test image. However, in other examples, the training component(s) 136 may only project a portion of the features from the reference surface 140 to the test image. For example, the training component(s) 136 may identify one or more detected features from the test image that include one or more confidence values that satisfy a threshold value. The training component(s) 136 may then project one or more of the features from the reference surface 140 that correspond to the identified feature(s) from the test image. In other words, the training component(s) 136 may only project the feature(s) for which the final-base model(s) 122 was confident in determining.

The training component(s) 136 may then use the determined feature(s) for the test image and the projected feature(s) for the test image to fine-tune the final-base model(s) 122. For instance, in some examples, the training component(s) 136 may determine one or more losses based at least on one or more differences between the determined feature(s) and the projected feature(s). As described herein, the training component(s) 136 may use any technique to determine the difference(s), such as one or more distances between the determined feature(s) and the projected feature(s). The training component(s) 110 may then use the loss(es) to update one or more parameters, weights, and/or biases associated with the final-base model(s) 122. Based at least on training the final-base model(s) 122, the training component(s) 136 may then output an updated model(s) 142 associated with the specific sporting surface.

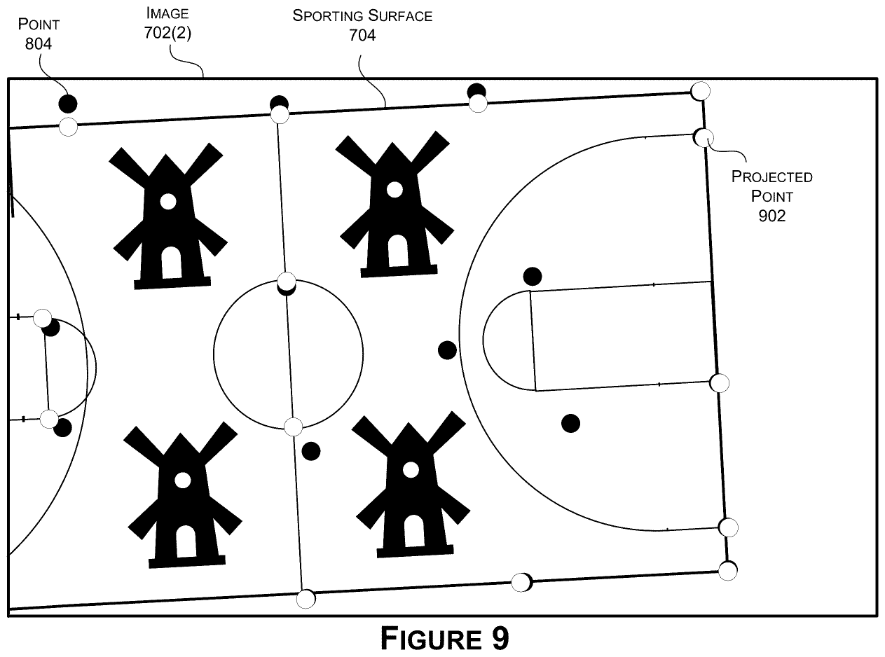

For more details, FIG. 9 illustrates an example of fine-tuning the final-base model(s) 122 using test data associated with the specific sporting surface 704, in accordance with some embodiments of the present disclosure. As shown, the training component(s) 136 may use the confidence values associated with the keypoints 804 for the second test image 702(2) to determine a portion of the keypoints 804 for performing the fine-tuning. For example, the training component(s) 136 may determine the portion of the keypoints 804 as being associated with confidence values that satisfy (e.g., are equal to or greater than) a threshold score.

The training component(s) 136 may then use the keypoint(s) 804 to determine the value(s) of the calibration parameter(s) for calibrating the specific sporting surface 704 with respect to the second test image 702(2). For example, the value(s) of the calibration parameter(s) may correspond to a projection matrix that relates a global coordinate system associated with the specific sporting surface 704 with a local coordinate system associated with the second test image 702(2). The training component(s) 136 may then use the value(s) of the calibration parameter(s) and the reference surface 202 to project a portion of the keypoints 206 from the specific sporting surface 704 (e.g., 3D features associated with the specific sporting surface 704) to the second test image 702(2), where projected keypoints 902 are shown on the second test image 702(2) (although only one is labeled for clarity reasons). As shown, the projected keypoints 902 may correspond to the keypoints 804.

The training component(s) 136 may then use the keypoints 804 along with the projected keypoints 902 to fine-tune the final-base model(s) 122. For instance, in some examples, the training component(s) 136 may identify distances between the keypoints 804 and the corresponding projected keypoints 902. The training component(s) 136 may then use the distances to determine one or more losses associated with the final-base model(s) 122. Additionally, the training component(s) 136 may use the loss(es) to update one or more parameters, weights, and/or biases associated with the final-base model(s) 122.

Referring back to the example of FIG. 1B, the process 124 may include using one or more evaluation components 144 to determine whether to perform one or more additional training stages associated with the updated model(s) 142 or whether the fine-tuning of the updated model(s) 142 is complete. As described herein, in some examples, the evaluation component(s) 144 may determine that the fine-tuning of the updated model(s) 142 is complete based at least on a threshold number of training stages being performed on the updated model(s) 142, such as one training stage, five training stages, ten training stages, and/or any other number of training stages. Additionally, or alternatively, in some examples, the evaluation component(s) 144 may determine that the fine-tuning of the updated model(s) 142 is complete using a convergence check. For instance, the evaluation component(s) 144 may determine that the fine-tuning is complete based at least on the updated model(s) 142 satisfying a threshold accuracy.

For example, the evaluation component(s) 144 may use the detected features associated with a test image and the projected features associated with the test image to determine an accuracy associated with the updated model(s) 142. In some examples, the evaluation component(s) 144 determines the accuracy based at least differences—such as distances—between the detected features and the corresponding projected features. The evaluation component(s) 144 may then determine that the fine-tuning of the updated model(s) 142 is not complete based at least on the accuracy not satisfying (e.g., being less than) the threshold accuracy or determine that the fine-tuning of the updated model(s) 142 is complete based at least on the accuracy satisfying (e.g., being equal to or greater than) the threshold accuracy.

In either of the examples, the process 124 may include performing another training stage using at least a portion of the process 124 when the evaluation component(s) 144 determines that the fine-tuning of the updated model(s) 142 is not complete. Alternatively, the process 124 may include the evaluation component(s) 144 outputting a final fine-tuned model(s) 146 when the evaluation component(s) 144 determines that the fine-tuning is complete. As described herein, the fine-tuned model(s) 146 may then be trained not only on sporting surfaces that are associated with a type of sport, but also trained on a specific sporting surface associated with the type of sport. This way, the fine-tuned model(s) 146 may better perform one or more processes—such as feature detection and/or camera calibration—for the appearance of the specific sporting surface.

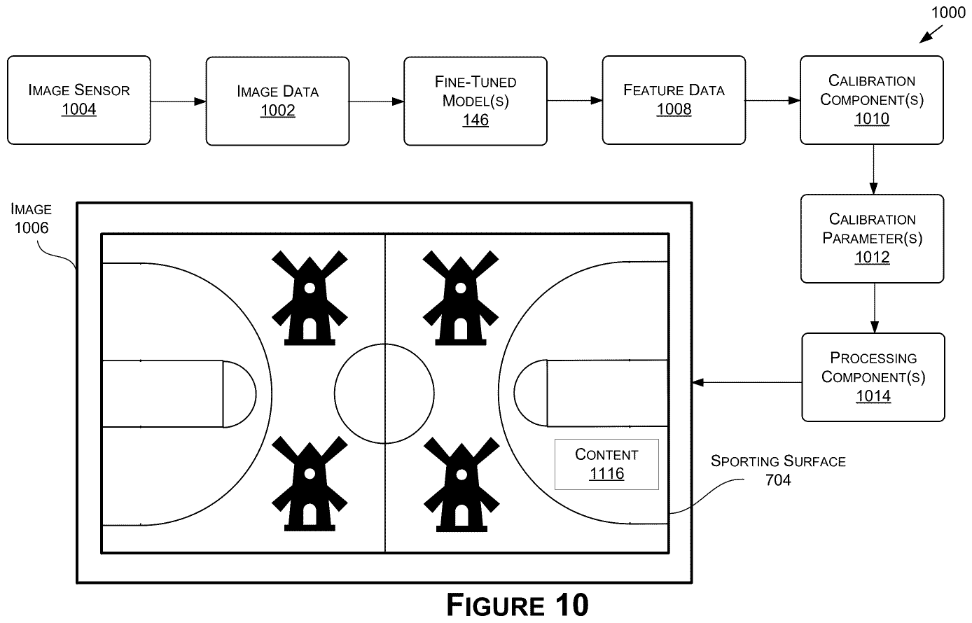

As described herein, by generating the fine-tuned model(s) 146 using one or more of the processes described herein, the fine-tuned model(s) 146 may be used to perform one or more tasks. For instance, FIG. 10 illustrates an example data flow diagram for a process 1000 of using one or more fine-tuned models to perform camera calibration with respect to a specific sporting surface, in accordance with some embodiments of the present disclosure. As shown, the process 1000 may initially include receiving image data 1002 obtained using one or more image sensors 1004. As described herein, in some examples, the image data 1002 may represent one or more images—such as an image 1006—depicting the specific sporting surface 704 associated with the fine-tuned model(s) 146. For example, the image sensor(s) 1004 may be used to broadcast a sporting event that is occurring at the specific sporting surface 704.

The process 1000 may then include the fine-tuned model(s) 146 processing the image data 1002 to determine feature data 1008. As described herein, the feature data 1006 may represent one or more features—such as one or more keypoints—associated with the image 1006. The process 1000 may then include using one or more calibration components 1010 to process the feature data 1008 and determine at least one or more values for one or more calibration parameters 1012 that relate the specific sporting surface 704 with respect to the image sensor 1004 and/or the image 1006 For instance, the value(s) of the calibration parameter(s) 1012 may relate a global coordinate system associated with the specific sporting surface 704 with a local coordinate system associated with the image 1006.

The process 1000 may then include one or more processing components 1014 using the value(s) of the calibration parameter(s) 1012 to perform one or more tasks. As shown, in the example of FIG. 10, the task(s) may include overlaying content 1116 at a determined location on the specific sporting surface 704 as represented by the image 1006. However, in other examples, the processing component(s) 1114 may use the value(s) of the calibration parameter(s) 1012 to perform any other task. Additionally, the process 1000 may continue to repeat where the fine-tuned model(s) 146 processes the image data 1002 to determine the value(s) of the calibration parameter(s) 1012 and the processing component(s) 1114 uses the value(s) of the calibration parameter(s) 1012 to perform one or more tasks. For instance, the process 1000 may repeat for every image, every other image, every fourth image, every tenth image, and/or using any other interval associated with the images represented by the image data 1002.

While the example of FIG. 10 illustrates the calibration component(s) 1012 as being separate from the fine-tuned model(s) 146, in other examples, the fine-tuned model(s) 146 may be trained to both determine the feature data 1008 and the value(s) of the calibration parameter(s) 1012. In other words, the fine-tuned model(s) 146 may directly process the image data 1002 to determine the value(s) of the calibration parameter(s) 1012 without the need of additional processing.

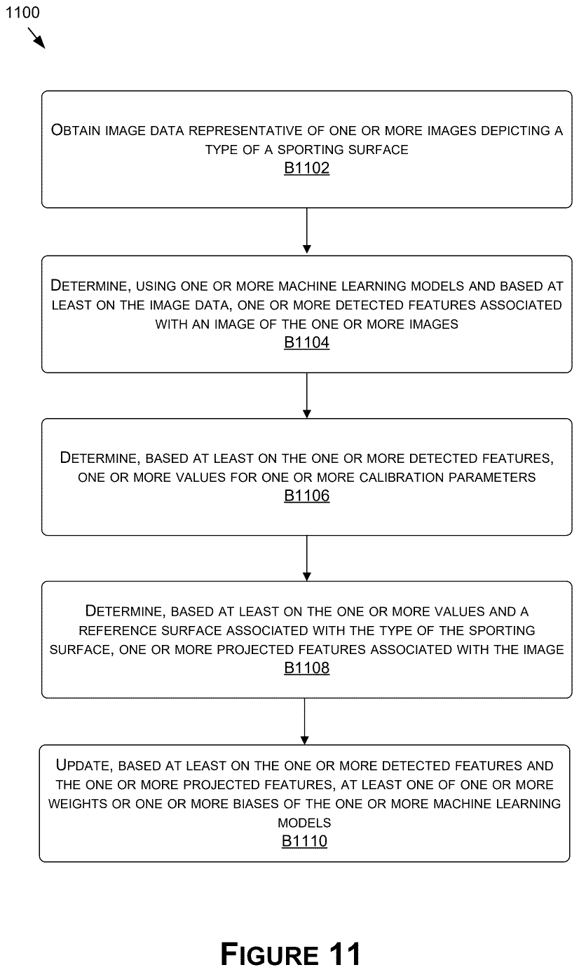

Now referring to FIGS. 11-13, each block of methods 1100, 1200, and 1300, described herein, comprises a computing process that may be performed using any combination of hardware, firmware, and/or software. For instance, various functions may be carried out by a processor executing instructions stored in memory. The methods 1100, 1200, and 1300 may also be embodied as computer-usable instructions stored on computer storage media. The methods 1100, 1200, and 1300 may be provided by a standalone application, a service or hosted service (standalone or in combination with another hosted service), or a plug-in to another product, to name a few. In addition, these methods 1100, 1200, and 1300 described, by way of example, with respect to FIGS. 1A-1B. However, these methods 1100, 1200, and 1300 may additionally or alternatively be executed by any one system, or any combination of systems, including, but not limited to, those described herein.

FIG. 11 illustrates a flow diagram showing a method 1100 for fine-tuning one or more machine learning models for performing camera calibration with respect to a sporting surface, in accordance with some embodiments of the present disclosure. The method 1100, at block B1102, may include obtaining image data representative of one or more images depicting a type of a sporting surface. For instance, the test data 126 may be obtained using the image sensor(s) 128. As described herein, the test data 126 may include image data representing the image(s) depicting a sporting surface that is associated with a type of sport. Additionally, the image(s) may depict an entirety of the sporting surface, a portion(s) of the sporting surface, an angle(s) of the sporting surface, an orientation(s) of the sporting surface, and/or any other any other configuration of the sporting surface.

The method 1100, at block B1104, may include determining, using one or more machine learning models and based at least on the image data, one or more detected features associated with an image of the one or more images. For instance, the final-base model(s) 122 may process the test data 126 to determine the annotated data 130 representing the detected feature(s) associated with the image. As described herein, in some examples, the final-base model(s) 122 may have previously been trained to detect features and/or perform camera calibration with respect to sporting surfaces associated with the type of sport. Additionally, the detected feature(s) may include one or more detected keypoints, one or more detected lines, and/or any other type of feature.

The method 1100, at block B1106, may include determining, based at least on the one or more detected features, one or more values for one or more calibrations parameters. For instance, the training component(s) 136 may use the detected feature(s) represented by the annotated data 130 (and/or the training data 134 after sampling) to determine the value(s) of the calibration parameter(s) 138. As described herein, the value(s) of the calibration parameter(s) 138 may be associated with a matrix that relates a global coordinate system associated with the sporting surface with a reference coordinate system associated with the image.

The method 1100, at block B1108, may include determining, based at least on the one or more values and a reference surface associated with the type of the sporting surface, one or more projected features associated with the image. For instance, the training component(s) 136 may use the value(s) of the calibration parameter(s) 138 to project the 3D feature(s) from the reference surface 140 to the image in order to determine the projected feature(s). As described herein, the projected feature(s) may include one or more projected keypoints, one or more projected lines, and/or any other type of feature. Additionally, in some examples, the projected feature(s) may correspond to the detected feature(s).

The method 1100, at block B1110, may include updating, based at least on the one or more detected features and the one or more projected features, at least one of one or more weights or one or more biases of the one or more machine learning models. For instance, the training component(s) 136 may use the detected feature(s) and the projected feature(s) to update the final-base model(s) 122. As described herein, in some examples, the training component(s) 136 may determine one or more losses using the detected feature(s) and the projected feature(s), such as based on one or more distances between the detected feature(s) and the projected feature(s). The training component(s) 136 may then update the final-base model(s) 122 based at least on the loss(es). As such, the output of the updating may include the final-base model(s) 122 that is associated with the sporting surface.

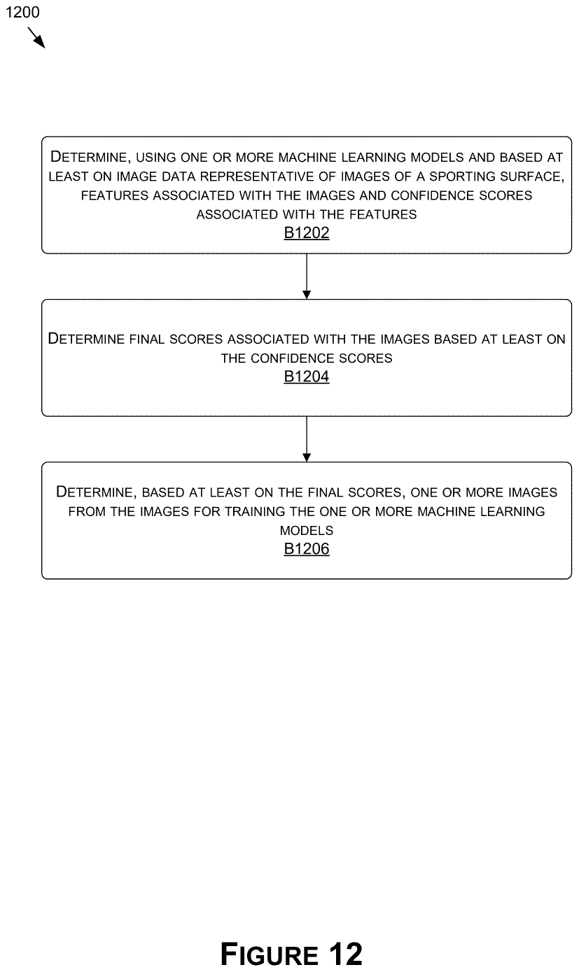

FIG. 12 illustrates a flow diagram showing a method 1200 for sampling images to determine one or more images for fine-tuning one or more machine learning models, in accordance with some embodiments of the present disclosure. The method 1200, at block B1202, may include determining, using one or more machine learning models and based at least on image data representative of images of a sporting surface, features associated with the images and confidence scores associated with the features. For instance, the final-base model(s) 122 may process the test data 126 that includes at least the image data representing the images. Based at least on the processing, the final-base model(s) 122 may generate annotated data 130 representing at least the features for the sporting surface as represented by the images and the confidence values for the features.

The method 1200, at block B1204, may include determining final scores associated with the images based at least on the confidence scores. For instance, the sampling component(s) 132 may process the annotated data 130 to determine the final scores associated with the images. As described herein, the sampling component(s) 132 may determine the final scores associated with the images using the average of the confidence scores, the median of the confidence scores, the mode of the confidence scores, and/or using any other mathematical formula.

The method 1200, at block B1206, may include determining, based at least on the final scores, one or more images from the images for training the one or more machine learning models. For instance, the sampling component(s) 132 may use the final scores associated with the images to determine the image(s) for fine-turning the final-base model(s) 122. As described herein, in some examples, the sampling component(s) 132 may determine the image(s) as being associated with one or more of the highest final scores.

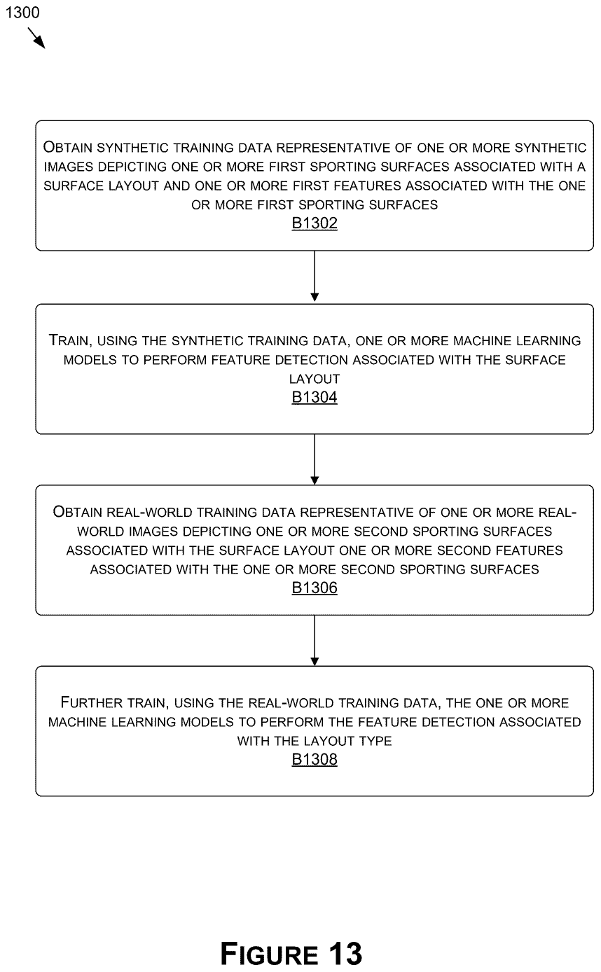

FIG. 13 illustrates a flow diagram showing a method 1300 for training one or more machine learning models to perform feature detection using both synthetic data and real-world data, in accordance with some embodiments of the present disclosure. The method 1300, at block B1302, may include obtaining synthetic training data representative of one or more synthetic images depicting one or more first sporting surfaces associated with a surface layout and one or more first features associated with the one or more first sporting surfaces. For instance, the simulation component(s) 104 may generate the synthetic training data 106 that represents the synthetic image(s) and the first feature(s) associated with the synthetic image(s). As described herein, the synthetic image(s) may depict the first sporting surface(s) associated with the surface layout of a sport.

The method 1300, at block B1304, may include training, using the synthetic training data, one or more machine learning models to perform feature detection associated with the surface layout. For instance, the training component(s) 110 may train the model(s) 102 using the synthetic training data 106 to generate the initial-base model(s) 112. As described herein, the initial-base model(s) 112 may be configured to perform feature detection associated with the surface layout. Additionally, the feature detection may be used to perform one or more additional tasks, such as camera calibration associated with the surface layout.

The method 1300, at block B1306, may include obtaining real-world training data representative of one or more real-world images depicting one or more second sporting surfaces associated with the surface layout and one or more second features associated with the one or more second sporting surfaces. For instance, the image sensor(s) 114 may obtain the real-world training data 116 that represents the real-world image(s) and the second feature(s) associated with the real-world image(s). As described herein, the real-world image(s) may depict the second sporting surface(s) that is also associated with the surface layout of the sport.

The method 1300, at block B1308, may include further training, using the real-world training data, the one or more machine learning models to perform the camera calibration associated with the layout type. For instance, the training component(s) 120 may train the initial-base model(s) 112 using the real-world training data 116 to generate the final-base model(s) 122. As described herein, the final-base model(s) 122 may be configured to perform the feature detection associated with the surface layout. Additionally, the feature detection may be used to perform additional tasks, such as camera calibration associated with the surface layout.

### Example Computing Device

FIG. 14 is a block diagram of an example computing device(s) 1400 suitable for use in implementing some embodiments of the present disclosure. Computing device 1400 may include an interconnect system 1402 that directly or indirectly couples the following devices: memory 1404, one or more central processing units (CPUs) 1406, one or more graphics processing units (GPUs) 1408, a communication interface 1410, input/output (I/O) ports 1412, input/output components 1414, a power supply 1416, one or more presentation components 1418 (e.g., display(s)), and one or more logic units 1420. In at least one embodiment, the computing device(s) 1400 may comprise one or more virtual machines (VMs), and/or any of the components thereof may comprise virtual components (e.g., virtual hardware components). For non-limiting examples, one or more of the GPUs 1408 may comprise one or more vGPUs, one or more of the CPUs 1406 may comprise one or more vCPUs, and/or one or more of the logic units 1420 may comprise one or more virtual logic units. As such, a computing device(s) 1400 may include discrete components (e.g., a full GPU dedicated to the computing device 1400), virtual components (e.g., a portion of a GPU dedicated to the computing device 1400), or a combination thereof.

Although the various blocks of FIG. 14 are shown as connected via the interconnect system 1402 with lines, this is not intended to be limiting and is for clarity only. For example, in some embodiments, a presentation component 1418, such as a display device, may be considered an I/O component 1414 (e.g., if the display is a touch screen). As another example, the CPUs 1406 and/or GPUs 1408 may include memory (e.g., the memory 1404 may be representative of a storage device in addition to the memory of the GPUs 1408, the CPUs 1406, and/or other components). In other words, the computing device of FIG. 14 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 14.

The interconnect system 1402 may represent one or more links or busses, such as an address bus, a data bus, a control bus, or a combination thereof. The interconnect system 1402 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1406 may be directly connected to the memory 1404. Further, the CPU 1406 may be directly connected to the GPU 1408. Where there is direct, or point-to-point connection between components, the interconnect system 1402 may include a PCIe link to carry out the connection. In these examples, a PCI bus need not be included in the computing device 1400.

The memory 1404 may include any of a variety of computer-readable media. The computer-readable media may be any available media that may be accessed by the computing device 1400. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1404 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1400. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1406 may be configured to execute at least some of the computer-readable instructions to control one or more components of the computing device 1400 to perform one or more of the methods and/or processes described herein. The CPU(s) 1406 may each include one or more cores (e.g., one, two, four, eight, twenty-eight, seventy-two, etc.) that are capable of handling a multitude of software threads simultaneously. The CPU(s) 1406 may include any type of processor, and may include different types of processors depending on the type of computing device 1400 implemented (e.g., processors with fewer cores for mobile devices and processors with more cores for servers). For example, depending on the type of computing device 1400, the processor may be an Advanced RISC Machines (ARM) processor implemented using Reduced Instruction Set Computing (RISC) or an x86 processor implemented using Complex Instruction Set Computing (CISC). The computing device 1400 may include one or more CPUs 1406 in addition to one or more microprocessors or supplementary co-processors, such as math co-processors.

In addition to or alternatively from the CPU(s) 1406, the GPU(s) 1408 may be configured to execute at least some of the computer-readable instructions to control one or more components of the computing device 1400 to perform one or more of the methods and/or processes described herein. One or more of the GPU(s) 1408 may be an integrated GPU (e.g., with one or more of the CPU(s) 1406 and/or one or more of the GPU(s) 1408 may be a discrete GPU. In embodiments, one or more of the GPU(s) 1408 may be a coprocessor of one or more of the CPU(s) 1406. The GPU(s) 1408 may be used by the computing device 1400 to render graphics (e.g., 3D graphics) or perform general purpose computations. For example, the GPU(s) 1408 may be used for General-Purpose computing on GPUs (GPGPU). The GPU(s) 1408 may include hundreds or thousands of cores that are capable of handling hundreds or thousands of software threads simultaneously. The GPU(s) 1408 may generate pixel data for output images in response to rendering commands (e.g., rendering commands from the CPU(s) 1406 received via a host interface). The GPU(s) 1408 may include graphics memory, such as display memory, for storing pixel data or any other suitable data, such as GPGPU data. The display memory may be included as part of the memory 1404. The GPU(s) 1408 may include two or more GPUs operating in parallel (e.g., via a link). The link may directly connect the GPUs (e.g., using NVLINK) or may connect the GPUs through a switch (e.g., using NVSwitch). When combined together, each GPU 1408 may generate pixel data or GPGPU data for different portions of an output or for different outputs (e.g., a first GPU for a first image and a second GPU for a simulated image). Each GPU may include its own memory, or may share memory with other GPUs.

In addition to or alternatively from the CPU(s) 1406 and/or the GPU(s) 1408, the logic unit(s) 1420 may be configured to execute at least some of the computer-readable instructions to control one or more components of the computing device 1400 to perform one or more of the methods and/or processes described herein. In embodiments, the CPU(s) 1406, the GPU(s) 1408, and/or the logic unit(s) 1420 may discretely or jointly perform any combination of the methods, processes and/or portions thereof. One or more of the logic units 1420 may be part of and/or integrated in one or more of the CPU(s) 1406 and/or the GPU(s) 1408 and/or one or more of the logic units 1420 may be discrete components or otherwise external to the CPU(s) 1406 and/or the GPU(s) 1408. In embodiments, one or more of the logic units 1420 may be a coprocessor of one or more of the CPU(s) 1406 and/or one or more of the GPU(s) 1408.

Examples of the logic unit(s) 1420 include one or more processing cores and/or components thereof, such as Data Processing Units (DPUs), Tensor Cores (TCs), Tensor Processing Units(TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1410 may include one or more receivers, transmitters, and/or transceivers that enable the computing device 1400 to communicate with other computing devices via an electronic communication network, included wired and/or wireless communications. The communication interface 1410 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1420 and/or communication interface 1410 may include one or more data processing units (DPUs) to transmit data received over a network and/or through interconnect system 1402 directly to (e.g., a memory of) one or more GPU(s) 1408.

The I/O ports 1412 may enable the computing device 1400 to be logically coupled to other devices including the I/O components 1414, the presentation component(s) 1418, and/or other components, some of which may be built in to (e.g., integrated in) the computing device 1400. Illustrative I/O components 1414 include a microphone, mouse, keyboard, joystick, game pad, game controller, satellite dish, scanner, printer, wireless device, etc. The I/O components 1414 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1400. The computing device 1400 may be include depth cameras, such as stereoscopic camera systems, infrared camera systems, RGB camera systems, touchscreen technology, and combinations of these, for gesture detection and recognition. Additionally, the computing device 1400 may include accelerometers or gyroscopes (e.g., as part of an inertia measurement unit (IMU)) that enable detection of motion. In some examples, the output of the accelerometers or gyroscopes may be used by the computing device 1400 to render immersive augmented reality or virtual reality.

The power supply 1416 may include a hard-wired power supply, a battery power supply, or a combination thereof. The power supply 1416 may provide power to the computing device 1400 to enable the components of the computing device 1400 to operate.

The presentation component(s) 1418 may include a display (e.g., a monitor, a touch screen, a television screen, a heads-up-display (HUD), other display types, or a combination thereof), speakers, and/or other presentation components. The presentation component(s) 1418 may receive data from other components (e.g., the GPU(s) 1408, the CPU(s) 1406, DPUs, etc.), and output the data (e.g., as an image, video, sound, etc.).

### Example Data Center

FIG. 15 illustrates an example data center 1500 that may be used in at least one embodiments of the present disclosure. The data center 1500 may include a data center infrastructure layer 1510, a framework layer 1520, a software layer 1530, and/or an application layer 1540.

As shown in FIG. 15, the data center infrastructure layer 1510 may include a resource orchestrator 1512, grouped computing resources 1514, and node computing resources (“node C.R.s”) 1516(1)-1516(N), where “N” represents any whole, positive integer. In at least one embodiment, node C.R.s 1516(1)-1516(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1516(1)-1516(N) may correspond to a server having one or more of the above-mentioned computing resources. In addition, in some embodiments, the node C.R.s 1516(1)-15161(N) may include one or more virtual components, such as vGPUs, vCPUs, and/or the like, and/or one or more of the node C.R.s 1516(1)-1516(N) may correspond to a virtual machine (VM).

In at least one embodiment, grouped computing resources 1514 may include separate groupings of node C.R.s 1516 housed within one or more racks (not shown), or many racks housed in data centers at various geographical locations (also not shown). Separate groupings of node C.R.s 1516 within grouped computing resources 1514 may include grouped compute, network, memory or storage resources that may be configured or allocated to support one or more workloads. In at least one embodiment, several node C.R.s 1516 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1512 may configure or otherwise control one or more node C.R.s 1516(1)-1516(N) and/or grouped computing resources 1514. In at least one embodiment, resource orchestrator 1512 may include a software design infrastructure (SDI) management entity for the data center 1500. The resource orchestrator 1512 may include hardware, software, or some combination thereof.

In at least one embodiment, as shown in FIG. 15, framework layer 1520 may include a job scheduler 1533, a configuration manager 1534, a resource manager 1536, and/or a distributed file system 1538. The framework layer 1520 may include a framework to support software 1532 of software layer 1530 and/or one or more application(s) 1542 of application layer 1540. The software 1532 or application(s) 1542 may respectively include web-based service software or applications, such as those provided by Amazon Web Services, Google Cloud and Microsoft Azure. The framework layer 1520 may be, but is not limited to, a type of free and open-source software web application framework such as Apache Spark™ (hereinafter “Spark”) that may utilize distributed file system 1538 for large-scale data processing (e.g., “big data”). In at least one embodiment, job scheduler 1533 may include a Spark driver to facilitate scheduling of workloads supported by various layers of data center 1500. The configuration manager 1534 may be capable of configuring different layers such as software layer 1530 and framework layer 1520 including Spark and distributed file system 1538 for supporting large-scale data processing. The resource manager 1536 may be capable of managing clustered or grouped computing resources mapped to or allocated for support of distributed file system 1538 and job scheduler 1533. In at least one embodiment, clustered or grouped computing resources may include grouped computing resource 1514 at data center infrastructure layer 1510. The resource manager 1536 may coordinate with resource orchestrator 1512 to manage these mapped or allocated computing resources.

In at least one embodiment, software 1532 included in software layer 1530 may include software used by at least portions of node C.R.s 1516(1)-1516(N), grouped computing resources 1514, and/or distributed file system 1538 of framework layer 1520. One or more types of software may include, but are not limited to, Internet web page search software, e-mail virus scan software, database software, and streaming video content software.

In at least one embodiment, application(s) 1542 included in application layer 1540 may include one or more types of applications used by at least portions of node C.R.s 1516(1)-1516(N), grouped computing resources 1514, and/or distributed file system 1538 of framework layer 1520. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1534, resource manager 1536, and resource orchestrator 1512 may implement any number and type of self-modifying actions based on any amount and type of data acquired in any technically feasible fashion. Self-modifying actions may relieve a data center operator of data center 1500 from making possibly bad configuration decisions and possibly avoiding underutilized and/or poor performing portions of a data center.

The data center 1500 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1500. In at least one embodiment, trained or deployed machine learning models corresponding to one or more neural networks may be used to infer or predict information using resources described above with respect to the data center 1500 by using weight parameters calculated through one or more training techniques, such as but not limited to those described herein.

In at least one embodiment, the data center 1500 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1400 of FIG. 14—e.g., each device may include similar components, features, and/or functionality of the computing device(s) 1400. In addition, where backend devices (e.g., servers, NAS, etc.) are implemented, the backend devices may be included as part of a data center 1500, an example of which is described in more detail herein with respect to FIG. 15.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1400 described herein with respect to FIG. 14. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### EXAMPLE PARAGRAPHS

A: One or more processors comprising: processing circuitry to perform one or more camera calibrations associated with first image data corresponding to a dynamic field of view of a surface comprising one or more static, visual demarcations, the one or more camera calibrations performed determining one or more values for the one or more camera calibration using one or more machine learning models.

B: The one or more processors of claim 18, wherein the processing circuitry performs the one or more camera calibrations based on at least one of: one or more image feature coordinates, one or more image feature coordinates confidence scores, or an estimation between the one or more image feature coordinates and feature coordinates of the sporting surface.

C: The one or more processors of claim 18, wherein the one or more machine learning models are updated at least by: obtaining second image data representative of one or more images depicting a third sporting surface associated with the layout type; determining, using the one or more machine learning models and based at least on the second image data, one or more third features associated with an image of the one or more images of the third surface; determining, based at least on the one or more values and a reference surface that includes the layout type, one or more fourth features associated with the image; and updating, using the one or more third features and the one or more fourth features, the one or more machine learning models to perform the one or more camera calibrations associated with the third surface.

D: A method of fine-tuning one or more machine learning models, comprising: obtaining image data obtained using one or more image sensors and representative of one or more images depicting a statically-positioned surface comprising one or more visual demarcations; determining, using the one or more machine learning models and based at least on the image data, one or more first feature points associated with at least an image of the one or more images; determining, based at least on the one or more first feature points, one or more values for one or more calibration parameters corresponding to at least one image sensor of the one or more image sensors; determining, based at least on the one or more values and a reference layout associated with the surface, one or more second feature points associated with the image; and updating, based at least on the one or more first feature points and the one or more second feature points, one or more parameters of the one or more machine learning models to generate one or more fine-tuned machine learning models.

E: The method of claim 1, further comprising: determining, using the one or more machine learning models and based at least on the image data, one or more third feature points associated with a second image of the one or more images; determining one or more first confidence scores associated with the one or more first feature points and one or more second confidence scores associated with the one or more third feature points; and selecting the image to train the one or more machine learning models based at least on the one or more first confidence scores and the one or more second confidence scores.

F: The method of claim 1, wherein the determining the one or more first feature points comprises: determining, using the one or more machine learning models and based at least on the image data, first feature points associated with the image and confidence scores associated with the first feature points; and determining, based at least on the confidence scores, a set of the first feature points that includes at least the one or more first feature points.

G: The method of claim 1, wherein the reference layout indicates at least: one or more dimensions associated with the surface; and one or more three-dimensional feature points associated with the surface that correspond to the one or more first feature points.

H: The method of claim 1, wherein the determining the one or more second feature points associated with the image comprises projecting, based at least on the one or more values, one or more three-dimensional feature points indicated by the reference layout to the image to determine the one or more second feature points.

I: The method of claim 1, further comprising iterative fine-tuning via: determining, using the one or more fine-tuned machine learning model and based at least on the image data, one or more third feature points associated with a second image of the one or more images; determining, based at least on the one or more third feature points, one or more second values for the one or more calibration parameters; determining, based at least on the one or more third values and the reference layout, one or more fourth feature points associated with the second image; and further updating, based at least on the one or more third feature points and the one or more fourth feature points, the at least one of the one or more parameters of the one or more fine-tuned machine learning models.

J: The method of claim 1, further comprising: obtaining synthetic input data representative of one or more synthetic images depicting one or more surfaces associated with the reference layout and ground truth data representative of one or more ground truth feature points associated with the one or more synthetic images; and using the synthetic input data and the ground truth data to update the one or more machine learning models, wherein the determining the one or more first feature points uses the one or more machine learning models.

K: The method of claim 7, further comprising: obtaining real-world input data representative of one or more real-world images depicting one or more surfaces associated with the reference layout and ground truth data representative of one or more ground truth feature points associated with the one or more real-world images; and updating the one or more machine learning models using the real-world input data and the ground truth data, wherein the determining the one or more first feature points uses the one or more updated machine learning models.

L The method of claim 1, further comprising: determining, using the fine-tuned one or more machine learning models and based at least on second image data representative one or more second images depicting the surface, one or more third feature points associated with the one or more second images; determining, based at least on the one or more third feature points, one or more second values associated with the one or more calibration parameters; and performing, using the one or more second values, one or more tasks associated with the one or more second images.

M: A system comprising: one or more processors to: determine, using one or more machine learning models and based at least on image data obtained using one or more cameras and representative of one or more images depicting a surface comprising one or more static, visual demarcations, one or more first features associated with at least an image of the one or more images; determining, based at least on the one or more first features, one or more values for one or more camera calibration parameters; determining, based at least on the one or more values and a reference layout associated with the surface, one or more second features associated with the image; and update, based at least on the one or more first features and the one or more second features, the one or more machine learning models to perform camera calibration with respect to the surface.

N: The system of claim 10, wherein the one or more processors are further to: determine, using the one or more machine learning models and based at least on the image data, one or more third features associated with a second image of the one or more images; determine one or more first confidence scores associated with the one or more first features and one or more second confidence scores associated with the one or more third features; and select the image to update the one or more machine learning models based at least on the one or more first confidence scores and the one or more second confidence scores.

O: The system of claim 10, wherein the determination of the one or more first features comprises: determining, using the one or more machine learning models and based at least on the image data, first features associated with the image and confidence scores associated with the first features; and determining, based at least on the confidence scores, a set of the first features that includes at least the one or more first feature points.

P: The system of claim 10, wherein the reference layout indicates at least: one or more dimensions associated with the surface; and one or more three-dimensional features associated with the surface that correspond to the one or more first features.

Q: The system of claim 10, wherein the determination of the one or more second features associated with the image comprises projecting, based at least on the one or more values, one or more three-dimensional feature points indicated by the reference layout to the image to determine the one or more second features.

R: The system of claim 10, wherein the one or more processors are further to: determine, using the one or more machine learning models and based at least on the image data, one or more third features associated with at least a second image of the one or more images; determine, based at least on the one or more third features, one or more second values for the one or more calibration parameters; determine, based at least on the one or more second values and the reference layout, one or more fourth features associated with the image; and update, based at least on the one or more third features and the one or more fourth features, the one or more machine learning models to perform the camera calibration with respect to the surface.

S: The system of claim 10, wherein the one or more processors are further to: obtain training input data representative of one or more training images depicting one or more sporting surfaces associated with the reference layout and ground truth data representative of one or more ground truth features associated with the one or more training images; and updating the one or more machine learning models using the training input data and the ground truth data, wherein the one or more first features are determined using the one or more machine learning models.

T: The system of claim 10, wherein the system is comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system for performing one or more deep learning operations; a system implemented using an edge device; a system implemented using a robot; a system for performing one or more generative AI operations; a system for performing operations using one or more large language model (LLMs); a system for performing operations using one or more vision language models (VLMs); a system for performing operations using one or more multi-modal language models (MMLMs); a system for performing operations using one or more vision-language-action (VLA) models; a system for using or deploying one or more inference microservices; a system for performing one or more conversational AI operations; a system for generating synthetic data; a system for presenting at least one of virtual reality content, augmented reality content, or mixed reality content; a system incorporating one or more virtual machines (VMs); a system implemented at least partially in a data center; or a system implemented at least partially using cloud computing resources.

What is claimed is:

1. A method of fine-tuning one or more machine learning models, comprising:
obtaining image data obtained using one or more image sensors and representative of one or more images depicting a statically-positioned surface comprising one or more visual demarcations;
determining, using the one or more machine learning models and based at least on the image data, one or more first feature points associated with at least an image of the one or more images;
determining, based at least on the one or more first feature points, one or more values for one or more calibration parameters corresponding to at least one image sensor of the one or more image sensors;
determining, based at least on the one or more values and a reference layout associated with the surface, one or more second feature points associated with the image; and
updating, based at least on the one or more first feature points and the one or more second feature points, one or more parameters of the one or more machine learning models to generate one or more fine-tuned machine learning models.

2. The method of claim 1, further comprising:
determining, using the one or more machine learning models and based at least on the image data, one or more third feature points associated with a second image of the one or more images;
determining one or more first confidence scores associated with the one or more first feature points and one or more second confidence scores associated with the one or more third feature points; and
selecting the image to train the one or more machine learning models based at least on the one or more first confidence scores and the one or more second confidence scores.

3. The method of claim 1, wherein the determining the one or more first feature points comprises:
determining, using the one or more machine learning models and based at least on the image data, first feature points associated with the image and confidence scores associated with the first feature points; and
determining, based at least on the confidence scores, a set of the first feature points that includes at least the one or more first feature points.

4. The method of claim 1, wherein the reference layout indicates at least:
one or more dimensions associated with the surface; and
one or more three-dimensional feature points associated with the surface that correspond to the one or more first feature points.

5. The method of claim 1, wherein the determining the one or more second feature points associated with the image comprises projecting, based at least on the one or more values, one or more three-dimensional feature points indicated by the reference layout to the image to determine the one or more second feature points.

6. The method of claim 1, further comprising iterative fine-tuning via:
determining, using the one or more fine-tuned machine learning model and based at least on the image data, one or more third feature points associated with a second image of the one or more images;
determining, based at least on the one or more third feature points, one or more second values for the one or more calibration parameters;
determining, based at least on the one or more third values and the reference layout, one or more fourth feature points associated with the second image; and
further updating, based at least on the one or more third feature points and the one or more fourth feature points, the at least one of the one or more parameters of the one or more fine-tuned machine learning models.

7. The method of claim 1, further comprising:
obtaining synthetic input data representative of one or more synthetic images depicting one or more surfaces associated with the reference layout and ground truth data representative of one or more ground truth feature points associated with the one or more synthetic images; and
using the synthetic input data and the ground truth data to update the one or more machine learning models,
wherein the determining the one or more first feature points uses the one or more machine learning models.

8. The method of claim 7, further comprising:
obtaining real-world input data representative of one or more real-world images depicting one or more surfaces associated with the reference layout and ground truth data representative of one or more ground truth feature points associated with the one or more real-world images; and
updating the one or more machine learning models using the real-world input data and the ground truth data,
wherein the determining the one or more first feature points uses the one or more updated machine learning models.

9. The method of claim 1, further comprising:
determining, using the fine-tuned one or more machine learning models and based at least on second image data representative one or more second images depicting the surface, one or more third feature points associated with the one or more second images;
determining, based at least on the one or more third feature points, one or more second values associated with the one or more calibration parameters; and
performing, using the one or more second values, one or more tasks associated with the one or more second images.

10. A system comprising:
one or more processors to:
determine, using one or more machine learning models and based at least on image data obtained using one or more cameras and representative of one or more images depicting a surface comprising one or more static, visual demarcations, one or more first features associated with at least an image of the one or more images;
determining, based at least on the one or more first features, one or more values for one or more camera calibration parameters;
determining, based at least on the one or more values and a reference layout associated with the surface, one or more second features associated with the image; and
update, based at least on the one or more first features and the one or more second features, the one or more machine learning models to perform camera calibration with respect to the surface.

11. The system of claim 10, wherein the one or more processors are further to:
determine, using the one or more machine learning models and based at least on the image data, one or more third features associated with a second image of the one or more images;
determine one or more first confidence scores associated with the one or more first features and one or more second confidence scores associated with the one or more third features; and
select the image to update the one or more machine learning models based at least on the one or more first confidence scores and the one or more second confidence scores.

12. The system of claim 10, wherein the determination of the one or more first features comprises:
determining, using the one or more machine learning models and based at least on the image data, first features associated with the image and confidence scores associated with the first features; and
determining, based at least on the confidence scores, a set of the first features that includes at least the one or more first feature points.

13. The system of claim 10, wherein the reference layout indicates at least:
one or more dimensions associated with the surface; and
one or more three-dimensional features associated with the surface that correspond to the one or more first features.

14. The system of claim 10, wherein the determination of the one or more second features associated with the image comprises projecting, based at least on the one or more values, one or more three-dimensional feature points indicated by the reference layout to the image to determine the one or more second features.

15. The system of claim 10, wherein the one or more processors are further to:
determine, using the one or more machine learning models and based at least on the image data, one or more third features associated with at least a second image of the one or more images;
determine, based at least on the one or more third features, one or more second values for the one or more calibration parameters;
determine, based at least on the one or more second values and the reference layout, one or more fourth features associated with the image; and
update, based at least on the one or more third features and the one or more fourth features, the one or more machine learning models to perform the camera calibration with respect to the surface.

16. The system of claim 10, wherein the one or more processors are further to:
obtain training input data representative of one or more training images depicting one or more sporting surfaces associated with the reference layout and ground truth data representative of one or more ground truth features associated with the one or more training images; and
updating the one or more machine learning models using the training input data and the ground truth data,
wherein the one or more first features are determined using the one or more machine learning models.

17. The system of claim 10, wherein the system is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system implemented using a robot;
a system for performing one or more generative AI operations;
a system for performing operations using one or more large language model (LLMs);
a system for performing operations using one or more vision language models (VLMs);
a system for performing operations using one or more multi-modal language models (MMLMs);
a system for performing operations using one or more vision-language-action (VLA) models;
a system for using or deploying one or more inference microservices;
a system for performing one or more conversational AI operations;
a system for generating synthetic data;
a system for presenting at least one of virtual reality content, augmented reality content, or mixed reality content;
a system incorporating one or more virtual machines (VMs);
a system implemented at least partially in a data center; or
a system implemented at least partially using cloud computing resources.

18. One or more processors comprising:
processing circuitry to perform one or more camera calibrations associated with first image data corresponding to a dynamic field of view of a surface comprising one or more static, visual demarcations, the one or more camera calibrations performed determining one or more values for the one or more camera calibration using one or more machine learning models.

19. The one or more processors of claim 18, wherein the processing circuitry performs the one or more camera calibrations based on at least one of: one or more image feature coordinates, one or more image feature coordinates confidence scores, or an estimation between the one or more image feature coordinates and feature coordinates of the sporting surface.

20. The one or more processors of claim 18, wherein the one or more machine learning models are updated at least by:
obtaining second image data representative of one or more images depicting a third sporting surface associated with the layout type;
determining, using the one or more machine learning models and based at least on the second image data, one or more third features associated with an image of the one or more images of the third surface;
determining, based at least on the one or more values and a reference surface that includes the layout type, one or more fourth features associated with the image; and
updating, using the one or more third features and the one or more fourth features, the one or more machine learning models to perform the one or more camera calibrations associated with the third surface.
